(19) United States
(12) Patent Application Publication
(10) Pub. No.: US 2003/0046832 A1
(43) Pub. Date: Mar. 13, 2003

(54) Shoe soles and methods of manufacture

(76) Inventors: Klaus Knoerr, Hochstadt (DE); Hong Wen Zhong, Fuzhou (CN)

Correspondence Address: TESTA, HURWITZ & THIBEAULT, LLP, HIGH STREET TOWER, 125 HIGH STREET, BOSTON, MA, 02110, US

(21) Appl. No.: 10/105,866

(22) Filed: Mar. 25, 2002

(30) Foreign Application Priority Data
Mar. 26, 2001 (DE) 101 14 820.8

(51) Int. Cl. A43B 13/12; B29D 31/50

(52) U.S. Cl. 36/30 R; 36/31; 264/244

(57) ABSTRACT

The invention relates to a method of manufacturing a shoe sole, in particular for a sports shoe, wherein a preform of the sole is first produced from a first material and at least one second material in a common mold by injection molding and wherein subsequently the preform is vulcanized to obtain the finished sole.

### CROSS-REFERENCE TO RELATED APPLICATION

This application incorporates by reference, and claims priority to and the benefit of, German patent application serial number 10114820.8, which was filed on Mar. 26, 2001.

### TECHNICAL FIELD

The present invention relates to a sole for an article of footwear, in particular a sole manufactured by injection molding at least two different materials. Furthermore, the present invention relates to methods of manufacturing the sole.

### BACKGROUND

When shoes, such as sports shoes, are designed, there are many requirements regarding the mechanical properties of the sole that should be addressed. In running shoes, for example, good cushioning properties are advantageous in a heel portion of the sole to avoid excessive fatigue or injuries of the muscles and the joints of a wearer of the shoe due to the high ground reaction forces arising during initial ground contact with the heel. In another example, elastic properties are desirable in a forefoot portion of the sole to support the push-off with the ball of the foot during the final phase of the step cycle to reduce the energy necessary for walking or running. Further, in the case of sports shoes, the sole should be designed to avoid a supination or an excessive pronation of the foot during the course of motion.

For these reasons, soles are typically no longer manufactured from a single piece of homogeneously formed material. The above-mentioned biomechanical requirements are addressed typically by a plurality of different materials that are combined to form a sole that is appropriate for the specific field of use of the shoe. For example, cushioning elements in the heel portion are typically connected with one or more supporting elements that extend into different parts of the sole, depending on the design of the shoe. The sole can be either the overall sole of the shoe or only a midsole with characteristics relevant to the desired biomechanical properties, to which further sole layers, for example an outsole layer for improved grip, can be attached.

U.S. Pat. No. 4,642,911, the disclosure of which is hereby incorporated herein by reference in its entirety, discloses the use of two materials having different compressibilities, which are selectively combined in a forefoot part of a sole to avoid pronation or supination. When this sole is manufactured, two wedge-shaped elements are first separately manufactured and subsequently laminated to each other to produce the sole with the desired properties. This manufacturing method, however, leads to a substantial increase in the expenditure of the manufacturing and related costs, since the different parts of the sole are first separately manufactured and subsequently, in a further production step that is predominately manually performed, combined to form the finished sole. Furthermore, powerful glues with solvents are typically used for laminating, which may cause environmental problems during production, as well as during the later disposal of the shoes. Furthermore, the use of glues negatively affects the cushioning and elastic properties of the sole and leads to an increased overall weight of the shoe.

It is, therefore, an object of the present invention to provide a simpler and more cost-effective method for the manufacture of complex shoe soles from at least two different materials with different performance characteristics.

### SUMMARY OF THE INVENTION

The present invention relates to a low-cost method of manufacturing a sole element, particularly for athletic shoes. The shoe sole of the present invention overcomes the disadvantages of known methods for producing shoe soles, because the components of the sole are attached to each other without using additional materials, thereby reducing the materials and procedural steps necessary to produce the sole. Generally, according to the invention, the sole is manufactured by injection molding a first material and at least one second material in a common mold to create a preform, which is subsequently vulcanized to form the finished sole.

The common formation of the first material and the second material by injection molding renders a subsequent manual combining of the two parts of the sole superfluous. In addition, injection molding with several components allows a selective arrangement of the first material and/or the second material in different areas of the sole, such that soles produced by the method in accordance with the invention meet the above-discussed complex biomechanical requirements. If suitable first and second materials are selected, the subsequent vulcanization step assures a reliable connection that can withstand the forces arising during use for a long period of time and the use of toxic glues and corresponding solvents is no longer necessary.

The selection of the first material and the at least one second material depends on the respective biomechanical requirements of the sole. For example, materials having different densities can be used to obtain selective support of different foot areas of the sole by having different hardnesses and/or stiffnesses. In another example, the first material can have essentially elastic energy returning properties, while the second material can have essentially viscous energy damping properties. This combination of materials produces a cost-effectively manufactured sole, which substantially stores in the first material component(s) the energy of the deformation of the sole and later returns a significant portion of the energy in the course of movement. In the second material component(s), the ground reaction forces are viscously cushioned, i.e. the energy is not stored and returned, but “eliminated” by relaxational processes, such as damping and dissipation.

In one aspect, the invention relates to a method of manufacturing at least a portion of a sole of an article of footwear. The method includes the steps of injecting a first material and at least one second material in an injection mold to form a sole preform and vulcanizing the preform to form the portion of the sole from the first material and the second material.

In another aspect, the invention relates to a sole for an article of footwear, the sole includes a first material and a second material. The first material and the second material are injection molded in a mold and vulcanized.

In yet another aspect, the invention relates to an article of footwear including an upper and a sole. The sole includes a first material and a second material, wherein the first material and the second material are injection molded in a mold and vulcanized. The sole can further include an outsole and/or an insole.

In various embodiments of the foregoing aspects of the invention, the first material and the second material can be simultaneously injected into the injection mold or the first material and the second material can be sequentially injected into the injection mold. The vulcanization step can occur in a second mold. In one embodiment, the first material and the second material have essentially equal degrees of expansion that occur during the vulcanization step. The first material can have essentially elastic properties and the second material can have essentially viscous properties. In another embodiment, the injecting step can include injecting a third material into the mold.

Furthermore, the portion of the sole can have a heel region and the second material can be injected into the injection mold to form at least a portion of the heel region. The second material can be embedded into or encapsulated by the first material to form a highly viscous insert in the heel region. In one embodiment, the first material and the second material have different densities and the first material and the second material exhibit a different mechanical property or performance characteristic. The mechanical property can be selected from the group consisting of hardness, stiffness, resiliency, and compliancy.

In addition, the portion of the sole can have a midfoot region and the second material can be injected into the injection mold to form at least a portion of the midfoot region. In one embodiment, the portion of the sole can have a lateral support region and/or a medial support region and the second material can be injected into the injection mold to form at least a portion of the lateral support region, the medial support region, or both. The first material can be ethylene vinyl acetate (EVA) and the second material can be a polymer.

These and other objects, along with advantages and features of the present invention herein disclosed, will become apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

The drawings are not necessarily to scale, emphasis instead generally being placed upon illustrating the principles of the invention. In the following description, various embodiments of the present invention are described with reference to the following drawings, in which:

FIG. 1 is a flow chart illustrating the process steps of a method of manufacturing a shoe sole in accordance with the invention;

FIG. 2A is a schematic bottom view of one embodiment of a sole manufactured by the method illustrated in FIG. 1;

FIG. 2B is a schematic bottom view of another embodiment of a sole manufactured by the method illustrated in FIG. 1;

FIG. 2C is a schematic bottom view of another embodiment of a sole manufactured by the method illustrated in FIG. 1;

FIG. 2D is a schematic bottom view of another embodiment of a sole manufactured by the method illustrated in FIG. 1;

FIG. 3A is a schematic side view of a shoe including the sole of FIG. 2A;

FIG. 3B is a schematic side view of a shoe including the sole of FIG. 2B;

FIG. 3C is a schematic side view of a shoe including the sole of FIG. 2C; and

FIG. 3D is a schematic side view of a shoe including the sole of FIG. 2D.

### DETAILED DESCRIPTION OF THE INVENTION

Embodiments of the present invention are described below. It is, however, expressly noted that the present invention is not limited to these embodiments, but rather the intention is that modifications that are apparent to the person skilled in the art are also included. In particular, the present invention is not intended to be limited to soles for sports shoes, but rather it is to be understood that the present invention can also be used to produce soles or portions thereof for any article of footwear. Also, the methods disclosed herein can be applied to other items of manufacture besides footwear. Further, only a left or right sole and/or shoe is depicted in any given figure; however, it is to be understood that the left and right soles/shoes are typically mirror images of each other and the description applies to both left and right soles/shoes. In certain activities that require different left and right shoe configurations or performance characteristics, the shoes need not be mirror images of each other.

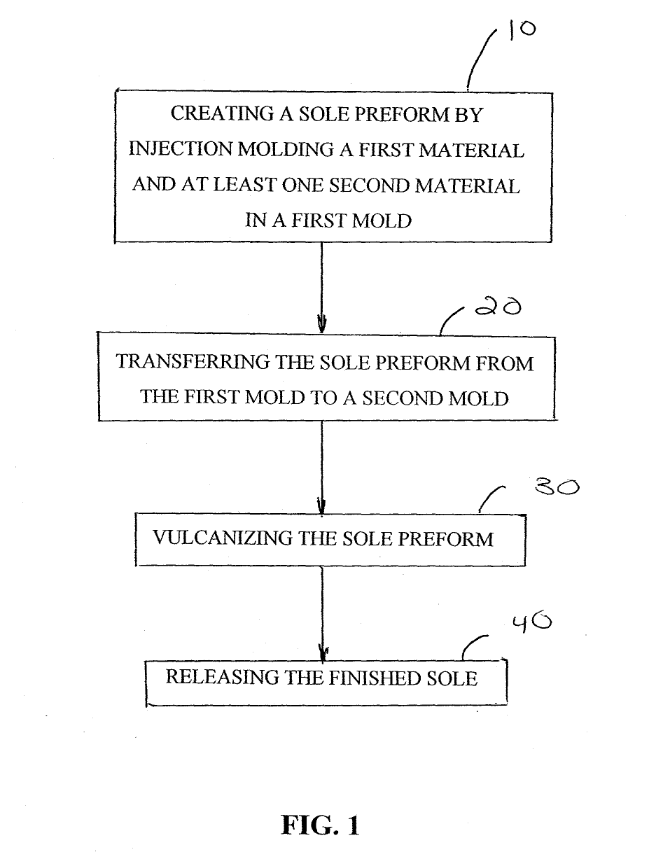

FIG. 1 is a flow chart illustrating the steps of one method in accordance with the invention. In a first step 10, a preform is injection molded in a mold from at least two different materials. Although the following description concerns a method where only two different materials are used, the use of one or more additional different materials is also contemplated and within the scope of the invention. In one embodiment, a particularly viscous, and therefore cushioning material, can be injected into the heel portion of the sole, a supporting element made from a denser EVA (i.e., a copolymer of ethylene vinyl acetate) can be injected into the forefoot portion, and a standard EVA of intermediate density can be injected into the remaining portion of the sole.

According to one embodiment of the method, different materials are simultaneously injected into the injection mold through two or more nozzles, which decreases the time required to produce the preform. The arrangement of the nozzles can correspond to the desired distribution of the materials in the sole. Alternatively, the two materials can be injected sequentially, one after the other, for example, where a partial solidification of the first material is desired prior to injecting the second material.

After the first step 10 is completed, the resulting preform is vulcanized 30. In one embodiment, the preform is transferred into a second mold prior to vulcanization 20. During the vulcanization step 30, the second mold allows the preform to expand into the final shape of the sole, which can be defined by the cavity of the second mold. Also, the two or more materials/components acquire their desired final properties, for example, viscosity, elasticity, etc.

When vulcanization 30 is carried out at temperatures in the range of about 155° C. to about 170° C., a cross-linking of the molecules of the two or more materials occurs, thereby leading to a chemical bond between the different materials/components of the sole, which provides a stable, reliable mechanical interconnection. The process parameters of the vulcanization step, i.e. the pressure and the above-discussed temperatures, as well as the time duration of this method step, are adapted to accommodate the materials used. Further, the degree of expansion of the different materials during vulcanization 30 may be controlled to avoid excessive mechanical tension in the interconnection of the different materials/components. For example, the materials may be selected so that the extent of respective expansion of the first material and the second material during vulcanization is similar in order to obtain good bonding between the two material/components and avoid excessive intestitial stress.

After vulcanization is completed, the finished sole is released 40. The finished sole can be further processed by, for example, mounting of a shoe upper and/or additional sole layers above and below the sole to complete manufacture of the shoe.

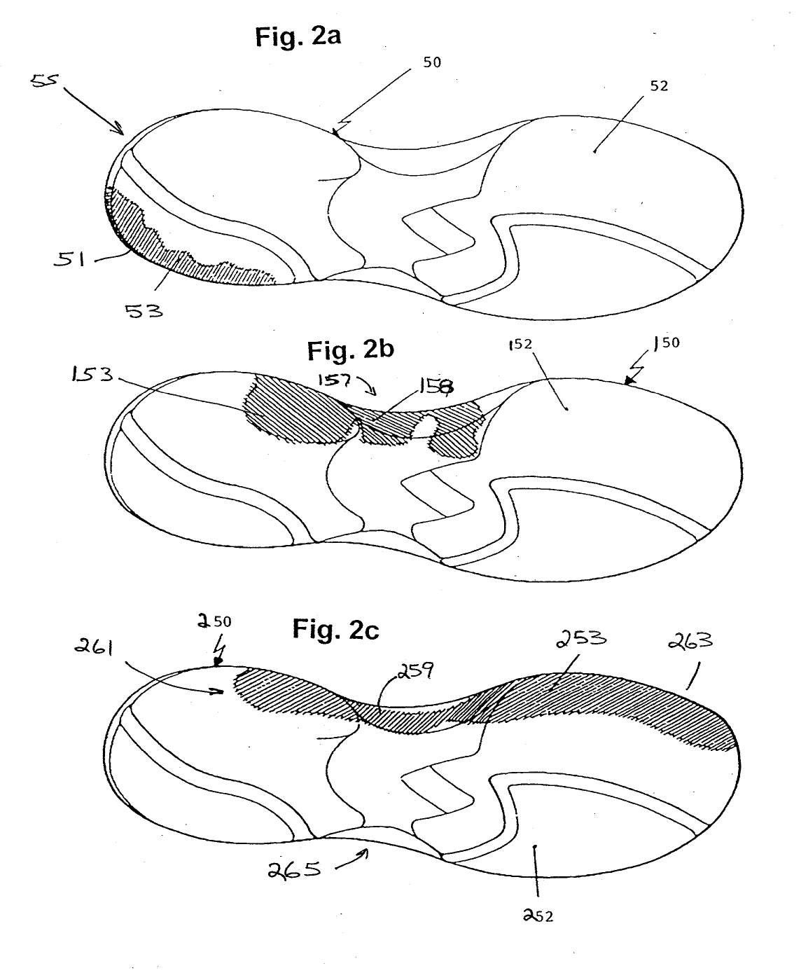

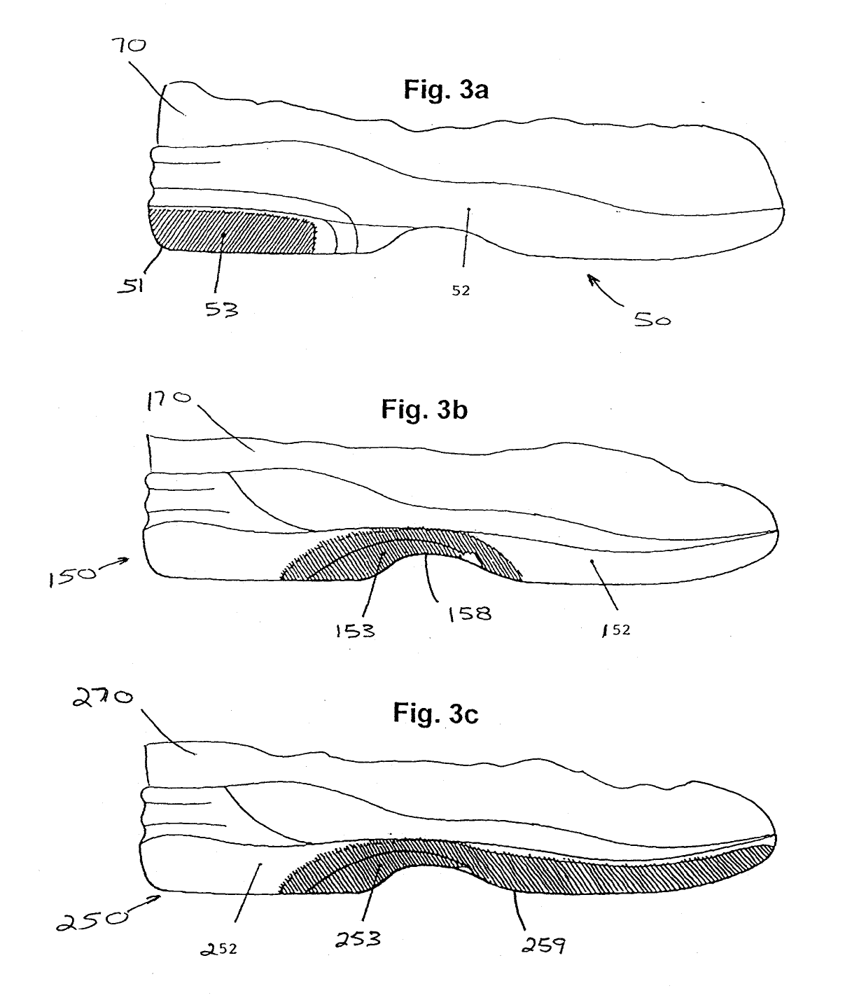

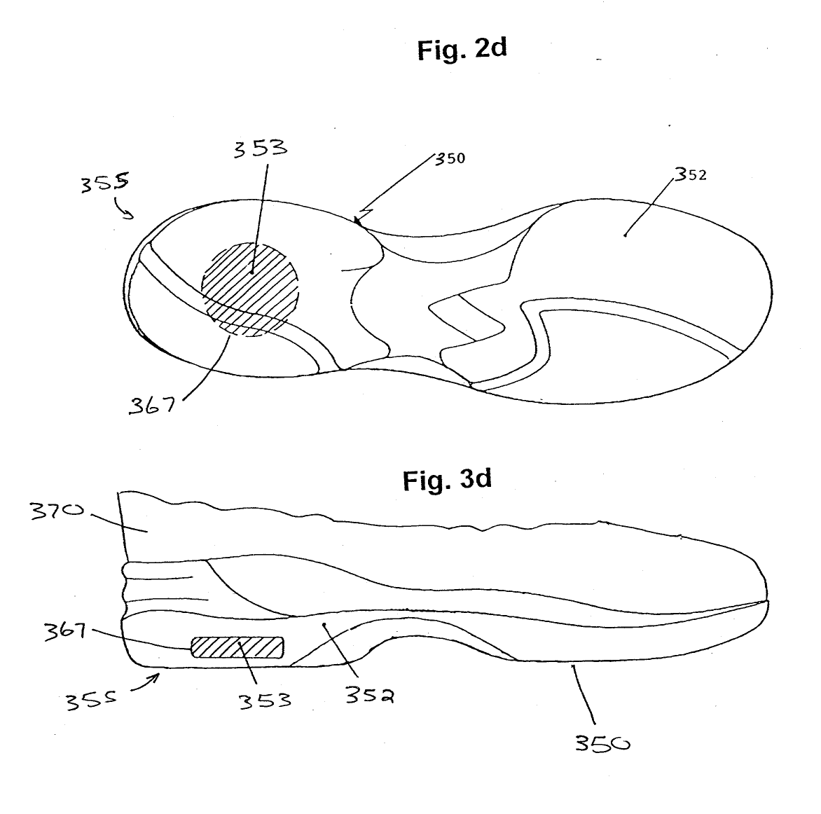

FIGS. 2A-2D depict bottom views of various configurations of a sole 50 produced by a method in accordance with the invention. FIGS. 3A-3D depict side views of a shoe including the soles of FIGS. 2A-2D, respectively. In FIGS. 2A and 3A, the shaded area corresponds to an integrally formed lateral heel portion 51 of a sole 50 having a first material 53 different from a second material 52 used in the remainder of the sole 50. In this embodiment, the first material 53 has highly viscous properties that cushion the high ground reaction forces arising during ground contact with the heel portion 5 5.

In one embodiment, the viscous material is a viscous polymer composition with the following components:

A) a polymer A, obtainable of at least a

A1) C₄-to C₁₀-diene as monomer A1, as well as

A2) a vinyl-aromatic C₈-to C₂₀-monomer as a monomer A2;

or

B) a polymer B, obtainable of at least a

B1) C₂-to C₂₀-olefin as a monomer B1,

B2) a monomer from a C₂-to C₁₀-vinyl-alcohol and C₂-to C₁₀-carboxylic acid as a monomer B2;

and, optionally, at least one of components C to E:

C) a polymer C, obtainable from at least one vinyl-aromatic monomer;

D) a halogen comprising polymer D, obtainable from at least one C₄-to C₁₀-diene and at least one halogen; and

E) a filler.

In various embodiments, the viscous material composition can be A and B together on their own or A and B together with at least one of components C, D, and E. Furthermore, the polymer composition can contain conventional release agent aids and additional compounds (component F), as are used, for example, to simplify removing the polymer composition from a mold. Further, all combinations of the component A with components B to E are possible. In addition, component B alone can be combined with components C to E. Examples of the material combinations of the components are given by the following letter combinations: AB, AC, AD, AE, AEC, ABCD, BC, ABC, ABCDEF, and ABCDE.

Furthermore, in a particular embodiment, the viscous polymer composition contains the following components:

A) 0 to 99.9 wt. % of polymer A, preferably about 5 to about 60 wt. %,

B) 0 to 99.9 wt. % of polymer B, preferably about 5 to about 60 wt. %,

C) 0 to 99.9 wt. % of polymer C, preferably about 5 to about 60 wt. %,

D) 0 to 90.4 wt. % of polymer D, preferably about 5 to about 50 wt. %,

E) 0 to 40 wt. % fillers as component E, preferably about 1 to about 20 wt. %,

wherein the sum of components A-E yields 100 wt. % and the polymer composition always contains at least one of the two components A and B and, if it contains A or B, it contains at least one further component chosen from C to E. The amount of a component F, if present, is up to 15 wt. %, preferably about 0.5 to about 5 wt. % in relation to the remaining polymer composition.

The above-described polymer composition can have an energy loss in the range of about 50% to about 80%, a dynamic stiffness at 200 N to 400 N in the range of about 80 N/mm to about 150 N/mm, a dynamic stiffness at 1000 N to 1500 N in the range of about 100 N/mm to about 400 N/mm, and a specific weight in the range of about 0.3 g/cm³ to about 0.8 g/cm³.

In contrast, the non-shaded area (second material 52) of the sole 50 depicted in FIGS. 2A and 3A, is manufactured from EVA. In a specific embodiment, the EVA material has a vinyl acetate content of about 18% to about 25%. The EVA may include other components, such as fillers, for example silicon-dioxide (SiO2) or titanium-dioxide (TiO2), cross-linking and processing agents, and blowing agents. Cross-linking agents include, for example, peroxides. Additionally, co-agents can be added to the material to harden the material during vulcanization. Such co-agents include, for example, acrylates and isocyanates.

The transition from the first material 53 to the second material 52 does not necessary follow a sharp line; to the contrary, an inter-diffusion in adjacent areas of the two materials 52, 53 during injection molding and/or vulcanization can be obtained. This controlled inter-diffusion of the materials can be used advantageously to obtain a smooth transition from one component to the other in order to obtain in certain areas of the sole a smooth change of the desired properties, for example, from viscous, i.e. predominantly cushioning properties, to more elastic properties.

FIGS. 2B and 3B depict a further example of a sole 150 manufactured according to one method of the invention and including an integrally formed medial supporting element 158 in a region corresponding to the wearer's arch. The major (i.e., unshaded) portion (second material 152) of the sole 150 is injection molded from an EVA having a standard density for shoe soles. The medial midfoot region 157 includes the simultaneously injection molded supporting element 158, which is also injection molded from an EVA, however, with a higher density. The higher density of the EVA material in the medial midfoot region 157 results, after vulcanization, in a higher stiffness of the supporting element 158 relative to the major portion 152 of the sole 150, thereby effectively supporting the arch of the wearer's foot. In contrast to conventional methods, the supporting element 158 is not separately formed and subsequently attached to the rest of the sole 150 by gluing or similar techniques, but is directly integrated into the sole 150. For an optical indication of the supporting element 158, it is possible to provide the supporting element 159 with a different color than the rest of the sole 150.

FIGS. 2C and 3C depict another example of a sole 250 manufactured according to one method of the invention, wherein a medial supporting element 259 made from an EVA of higher density is embedded into a midfoot region 261 and a forefoot region 263 of the sole 250, in order to avoid an excessive pronation of the wearer's foot during a step cycle. Alternatively or additionally, the method, according to the invention, allows the integration of similar supporting elements into a lateral side 265 of the sole 250.

FIGS. 2D and 3D depict yet another example of a sole 350 manufactured according to the method of the invention, wherein elastic and viscous materials are combined. As can be seen, a generally circular insert 367 is arranged in the heel portion 355 directly below the wearer's calcaneus bone. Alternatively, the insert 367 can be any combination of polygonal and/or arcuate shapes. The cushioning insert 367 is “hidden” within the surrounding material 352 by being encapsulated therein, thus protecting the wearer's heel bone during ground contact against excessive loads, without being subjected to premature wear by abrasion.

FIGS. 3A-3D depict the soles 50, 150, 250, 350 of FIGS. 2A-2D attached to an upper 70, 170, 270, 370. As can be seen in FIGS. 3A-3D, the multi-component injection molding of the sole 50, 150, 250, 350 in accordance with the invention creates a three-dimensional formation of the integrally embedded cushioning or supporting elements 51, 158, 259, 367, respectively. Thus, a corresponding arrangement of the injection nozzles during injection molding of the preform assures great freedom in the design and distribution of the two or more different components of the sole 50, 150, 250, 350.

Having described certain embodiments of the invention, it will be apparent to those of ordinary skill in the art that other embodiments incorporating the concepts disclosed herein may be used without departing from the spirit and scope of the invention. The described embodiments are to be considered in all respects as only illustrative and not restrictive. For example, materials other than EVA can be used, such as polyurethane, thermal plastic elastomer, polystyrene, polyvinyl chloride, phenolic, and polyolefin.

What is claimed is:

1. A method of manufacturing at least a portion of a sole of an article of footwear, the method comprising the steps of:
injecting a first material and at least one second material in an injection mold to form a sole preform; and
vulcanizing the preform to form the portion of the sole from the first material and the second material.

2. The method of claim 1, wherein the first material and the second material are simultaneously injected into the injection mold.

3. The method of claim 1, wherein the first material and the second material are sequentially injected into the injection mold.

4. The method of claim 1, wherein the vulcanization step occurs in a second mold.

5. The method of claim 1, wherein the first material and the second material have essentially equal degrees of expansion that occur during the vulcanization step.

6. The method of claim 1, wherein the injecting step further comprises injecting a third material into the injection mold.

7. The method of claim 1, wherein the first material comprises essentially elastic properties and the second material comprises essentially viscous properties.

8. The method of claim 7, wherein the portion of the sole comprises a heel region and the second material is injected into the injection mold to form at least a portion of the heel region.

9. The method of claim 8, wherein the second material is embedded in the first material to form a viscous insert in the heel region.

10. The method of claim 1, wherein the first material and the second material comprise different densities.

11. The method of claim 10, wherein the first material and the second material exhibit a different mechanical property.

12. The method of claim 11, wherein the mechanical property is selected from the group consisting of hardness, stiffness, resiliency, and compliancy.

13. The method of claim 10, wherein the portion of the sole comprises a midfoot region and the second material is injected into the injection mold to form at least a portion of the midfoot region.

14. The method of claim 10, wherein the portion of the sole comprises at least one of a lateral support region and a medial support region and the second material is injected into the injection mold to form at least a portion of at least one of the lateral support region and the medial support region.

15. The method of claim 1, wherein the first material comprises ethylene vinyl acetate.

16. The method of claim 1, wherein the second material comprises a polymer.

17. A sole for an article of footwear, the sole comprising:
a first material; and
a second material, wherein the first material and the second material are injection molded in a common mold and vulcanized.

18. The sole of claim 17, wherein the first material and the second material exhibit a different mechanical property.

19. The sole of claim 18, wherein the mechanical property is selected from the group consisting of hardness, stiffness, resiliency, and compliancy.

20. An article of footwear comprising:
an upper; and
a sole comprising:
a first material; and
a second material, wherein the first material and the second material are injection molded in a common mold and vulcanized.
